(19) United States
(12) Patent Application Publication
(10) Pub. No.: US 2004/0139786 A1
(43) Pub. Date: Jul. 22, 2004

(54) Testing device for a respiration product

(76) Inventors: Dirk Henf, Ovendorf (DE); Gunter Seemann, Palingen (DE)

Correspondence Address: MCGLEW & TUTTLE, PC, 1 SCARBOROUGH STATION PLAZA, SCARBOROUGH, NY, 10510-0827, US

(21) Appl. No.: 10/688,225

(22) Filed: Oct. 16, 2003

(30) Foreign Application Priority Data
Jan. 17, 2003 (DE) 103 01 518.3-22

(51) Int. Cl. G01M 19/00; G01M 3/02

(52) U.S. Cl. 73/37; 73/40

(57) ABSTRACT

A testing device for respirator products simulates breathing cycles with variable pressure rise. The device includes a fan (5) with a suction conduit (6) and with a pressure conduit (7). A reversing valve (10) is connected to the fan (5) and is designed to connect the pressure conduit (7) or the suction conduit (6) in terms of flow to the respirator product (2) in a predetermined time sequence in such a way that the particular free conduit is switched into the open position to the environment. A throttling element (11, 13) is located in the line section between the fan (5) and the respirator product (2) and which has a cross-sectional area that can be varied according to a preset manipulated variable.

### FIELD OF THE INVENTION

The present invention pertains to a device and to a process for testing respirator products and more particularly to a device system and method for testing respirator masks.

### BACKGROUND OF THE INVENTION

A device for testing breathing masks has become known from U.S. Pat. No. 3,486,366. A breathing mask is fastened to a testing head, and overpressure is admitted into the interior space of the mask by means of a fan and a change-over device. If leakage is detected during the overpressure operation, the user switches over to vacuum operation, and the leak can be sealed.

The prior-art testing device is suitable for the simple static function testing of respirator products, but breathing cycles with predetermined pressure curves cannot be simulated. Such a pressure curve may be, e.g., sinusoidal, with a continuous pressure rise up to a maximum and a subsequent decline to the initial value. Such a pressure curve is needed for the dynamic testing of breathing gas demand valves.

### SUMMARY OF THE INVENTION

The basic object of the present invention is to provide a testing device for respirator products and a process for testing respirator products, with which breathing cycles with variable pressure rise can be simulated.

The advantage of the present invention is essentially that the test gas flow can be increased or decreased by a throttling element, which is arranged in the line section or conduit between a test gas delivery device and the respirator product and which has a cross-sectional area that can be varied corresponding to a preset manipulated variable, as a result of which the pressure rise or the pressure drop of the respirator product to be tested can be affected. For example, diaphragms, whose cross-sectional area can be changed with a motor operator, are suitable for use as throttling elements. If the motor operator is actuated with a voltage that is variable over time, the cross-sectional area changes corresponding to the actuating voltage. A triangular voltage curve, in which the voltage rises to a maximum to subsequently drop to the initial value, proved to be especially useful. The cross-sectional area changes corresponding to the triangular voltage curve, beginning with a small cross-sectional area with strong throttling action to a large cross-sectional area with weak throttling action.

It is especially advantageous to perform the change-over from overpressure to vacuum operation with a valve element that is accommodated in a valve housing in a rotatingly movable manner and which swings between two end positions. The reversing valve has two valve inlets, which are connected to the pressure side and the suction side of a housing, respectively, and a valve outlet. A flow channel located in the valve element connects the suction side or the pressure side to the valve outlet depending on the position of the valve element. If the valve element is located between the end positions, only a partial area of the flow channel will overlap the respective valve inlet, as a result of which a throttling action is obtained. By contrast, the full flow cross section is available only in the end positions of the valve element.

The valve element is advantageously actuated by a motor. It is useful to detect the instantaneous position of the valve element by means of an angle of rotation pick-up. The motor is actuated on the basis of the preset set point and by the comparison of the actual value with the set point such that the angle of rotation becomes established corresponding to the preset set point.

The process according to the present invention for testing a respirator product is characterized by the following steps:

a housing with a suction conduit and a pressure conduit is connected to the respirator product via

a reversing valve,

the reversing valve is designed such that the suction conduit or the pressure conduit is in flow connection with the respirator product in a predetermined time sequence, while the respective free conduit is open toward the environment,

a throttling element is provided with a cross-sectional area that can be varied corresponding to a manipulated variable in the line section between the fan and the respirator product in order to control the flow of gas to the respirator product corresponding to a preset breathing pattern.

An exemplary embodiment of the present invention is shown in the figure and will be explained in greater detail below. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

FIG. 1 is a schematic view showing a testing device for a breathing mask;

FIG. 2 is a view of the testing device according to FIG. 1 in the testing position for overpressure operation; and

FIG. 3 is a view of the reversing valve in an intermediate position for the testing devices according to FIG. 1 or FIG. 2.

### DESCRIPTION OF THE PREFERRED EMBODIMENT

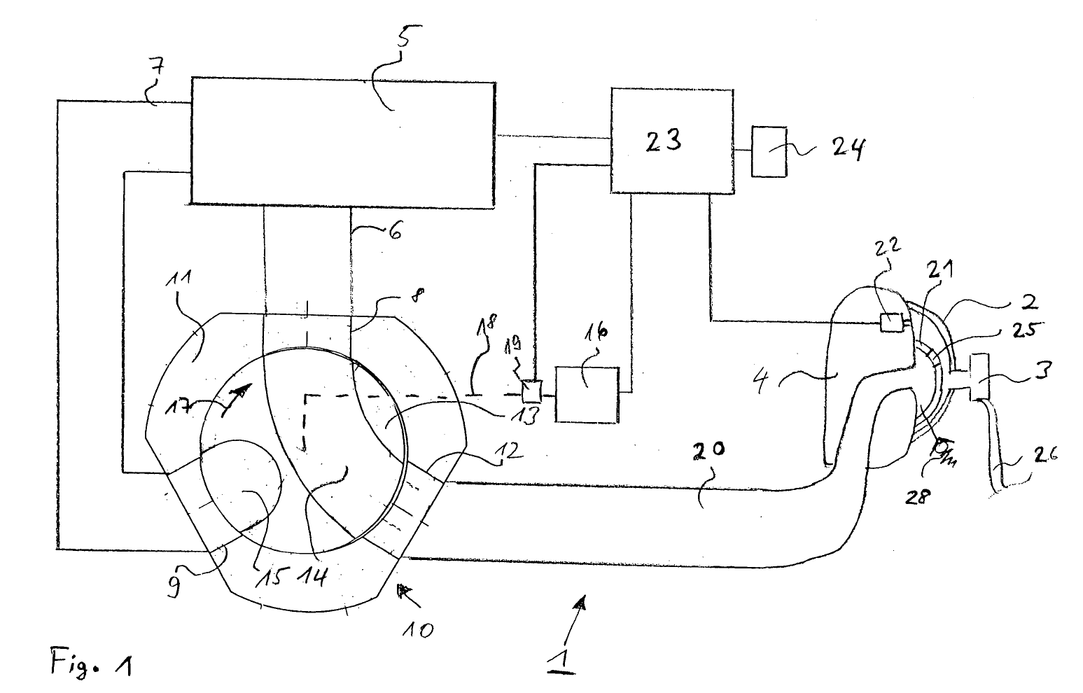

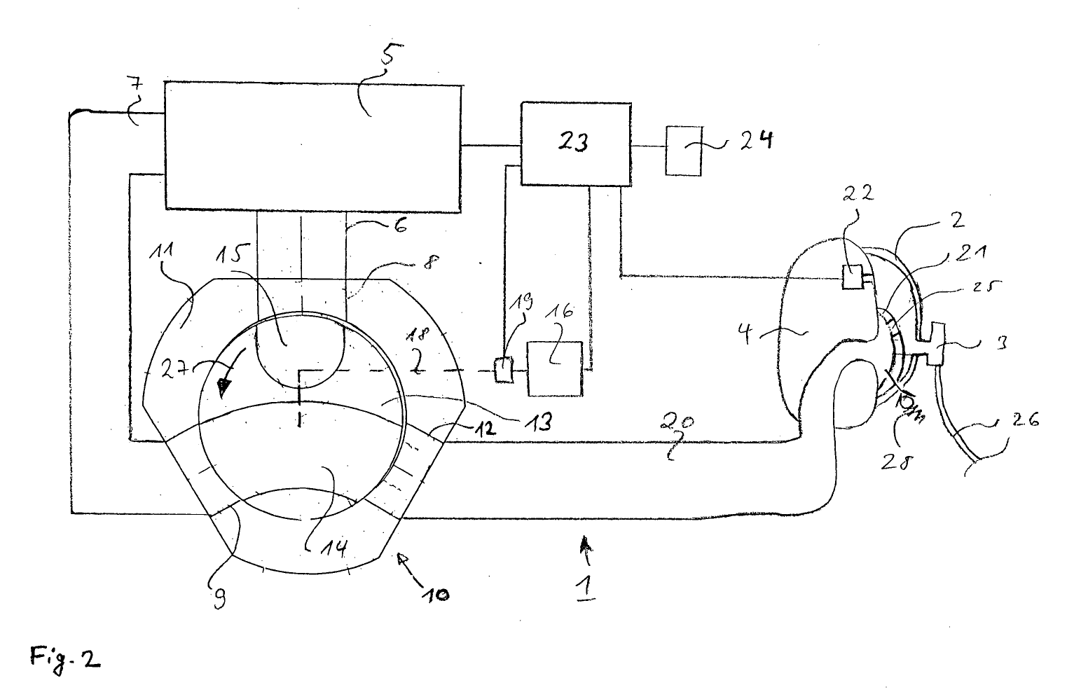

Referring to the drawings in particular, FIG. 1 schematically shows a testing device 1 for a breathing mask 2 for a demand oxygen system 3 at a testing head 4. The testing device 1 comprises a fan 5 with a suction conduit 6 and with a pressure conduit 7, which are connected to a first valve inlet 8 and to a second valve inlet 9 of a reversing valve 10. The reversing valve 10 comprises a valve housing 11 with the valve inlets 8, 9, a valve outlet 12 as well as a valve element 13 accommodated rotatably in the valve housing 11 with a flow channel 14 and with a ventilation channel 15. The valve element 13 is moved by a motor 16 in a pendulum-like manner such that the suction conduit 6 is connected to the valve outlet 12 via the flow channel 14 in a first end position as is illustrated in FIG. 1, while the flow channel 14 is located between the second valve inlet 9 and the valve outlet 12 in a second end position corresponding to FIG. 2. The swinging movement of the valve element 13 from the first end position into the second end position is illustrated by an arrow 17 in FIG. 1. An angle of rotation pick-up 19 connected to the drive shaft 18 of the motor 16, which said drive shaft is shown schematically, detects the instantaneous angular position of the valve element 13. The valve outlet 12 is connected to the testing head 4 via a flexible tube 20 and opens into an inner mask 21 of the breathing mask 2. The pressure within the breathing mask 2 in the area of the eyes is detected by a pressure sensor 22. The angle of rotation pick-up 19, the motor 16, the pressure sensor 22 and the fan 5 are connected to a computing and control unit 23, from which the testing procedure is controlled. Different testing programs can be set via an input unit 24.

The suction conduit 6 of the fan 5 is connected to the interior space of the inner mask 21 via the flow channel 14 in the first end position of the valve element 13 shown in FIG. 1. Vacuum is generated at the demand oxygen system 3 via an inspiration valve 25 fastened to the inner mask 21, so that the demand oxygen system opens. The demand oxygen system 3 is connected via a medium-pressure tube 26 to a compressed gas reservoir, not shown in detail in FIG. 1. The gas being delivered by the demand oxygen system 3 flows over the inspiration valve 25 and into the inner mask 21 and via the flexible tube 20 and the fan 5 to the ventilation channel 15 of the reversing valve 10. At the same time, the valve element 13 is swung by the motor 16 along the arrow 17 from the first end position into the second end position, as is shown in FIG. 2. The overlap between the flow channel 14, the first valve inlet 8 and the valve outlet 12 now decreases, as a result of which the flexible tube 20 is throttled. Since less gas can now be drawn off by the fan 5 from the flexible tube 20, the demand oxygen system 3 can establish a pressure equalization in the inner mask 21, as a result of which the demand oxygen system 3 is shut off. The motor 16 receives an actuating signal for the angle of rotation position of the valve element 13 via the control unit 23, and the actual value of the angular position is detected by the angle of rotation pick-up 19. The preset set point for the angle of rotation can be preselected via the input unit 24 corresponding to a sinusoidal-rectangular or triangular function. In the case of a triangular preset set point for the angle of rotation, an approximately sinusoidal pressure curve becomes established within the breathing mask 2, which can be measured and subsequently logged in the control unit 23.

FIG. 2 illustrates the reversing valve 10 in its second end position, in which the pressure conduit 7 is connected to the interior space of the inner mask 21 via the flow channel 14 and the flexible tube 20. The fan 5 now draws air in from the environment via the ventilation channel 15, and the gas drawn in can escape through an expiration valve 28 at the breathing mask 2. While the inspiration is simulated in the first end position of the reversing valve 10, FIG. 1, the second end position shown in FIG. 2 represents the expiration. Like components in FIG. 2 are designated by the same reference numbers as in FIG. 1. The valve element 13 is rotating along the arrow 27 during the transition from the second end position into the first end position of the reversing valve 10.

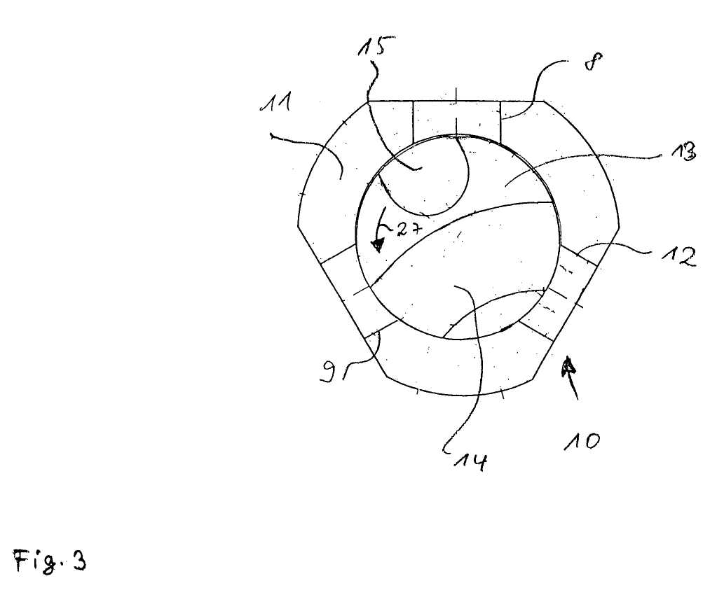

FIG. 3 shows the reversing valve 10 during the transition from the second end position, FIG. 2, into the first end position corresponding to FIG. 1. The valve element 13 is rotated now along the arrow 27. In the intermediate position of the valve element 13 shown in FIG. 3, the holes of the second valve inlet 9 and of the valve outlet 12 overlap the flow channel 14 only partially, as a result of which the reversing valve 10 acts as a throttling element because of the reduced cross section. The flow of gas from the second valve inlet 9 to the valve outlet 12 is continuously throttled during the rotation of the valve element 13 along the arrow 27 until the valve element 13 reaches the first end position.

While a specific embodiment of the invention has been shown and described in detail to illustrate the application of the principles of the invention, it will be understood that the invention may be embodied otherwise without departing from such principles.

What is claimed is:

1. A device for testing a respirator product, comprising:
a fan;
a suction conduit connected to said fan;
a pressure conduit connected to said fan;
a line section to the respirator product a reversing valve connecting said fan to one of said pressure conduit and said suction conduit in terms of flow to said respirator product via said to said line section switched in a predetermined time sequence and connecting the other of said pressure conduit and said suction conduit to the environment via an open position;
a throttling element located in the line section between said fan and said respirator product, said throttling element having a cross-sectional area that can be varied according to a preset manipulated variable.

2. A device in accordance with claim 1, wherein said reversing valve comprises a valve housing with a valve element swinging in a rotatingly movable manner therein between two end positions, wherein said valve housing has two said valve inlets connected to said suction conduit and to said pressure conduit and a valve outlet leading to said respirator product and said valve element has a flow channel that connects one of said valve inlets to said valve outlet as well as one of said valve inlets to a ventilation channel.

3. A device in accordance with claim 2, wherein the variable cross-sectional area of said throttling element is formed by the degree of overlap between the cross-sectional area of one of said valve inlets with the cross-sectional area of said flow channel wherein said valve element receives as the manipulated variable an angle of rotation position in relation to said valve housing.

4. A device in accordance with claim 1, wherein said valve element is actuated by a motor.

5. A device in accordance with claim 1, wherein the preset manipulated variable has a signal curve alternately rising proportionally or declining proportionally.

6. A process for testing a respirator product, the process comprising the steps of:
providing a fan with a suction conduit and with a pressure conduit;
connecting the fan to the respirator product via a reversing valve to provide flow connection of one of the suction conduit and the pressure conduit with the respirator product in a predetermined time sequence while said the other of said suction conduit and the pressure conduit is open toward the environment;
variably throttling the cross-sectional area of a line section between the fan and the respirator product corresponding to a manipulated variable in order to control the flow of gas to said respirator product corresponding to a preset breathing pattern.

7. A process in accordance with claim 6, wherein an approximately sinusoidal pressure curve is selected as the breathing pattern.

8. A respirator product testing system, comprising:
a fan;
a suction conduit connected to said fan;
a pressure conduit connected to said fan;
a line section to the respirator product
fluid control means for connecting said fan to one of said pressure conduit and said suction conduit in terms of flow to said respirator product via said to said line section switched in a predetermined time sequence and connecting the other of said pressure conduit and said suction conduit to the environment via an open position and variably throttling the cross-sectional area of a line section between the fan and the respirator product corresponding to a manipulated variable in order to control the flow of gas to said respirator product corresponding to a preset breathing pattern.

9. A device in accordance with claim 8, wherein said fluid control means comprises a reversing valve with a valve housing with two valve inlets connected selectively to said suction conduit and to said pressure conduit and a valve outlet leading to said respirator product and with a valve element having a flow channel that connects one of said valve inlets to said valve outlet as well as one of said valve inlets to a ventilation channel and said valve element flow channel is rotatingly movable between said inlets.

10. A device in accordance with claim 9, wherein the variable throttling of the cross-sectional area of the line section occurs based on a degree of overlap between the cross-sectional area of one of said valve inlets with the cross-sectional area of said flow channel wherein said valve element receives as the manipulated variable an angle of rotation position in relation to said valve housing.

11. A device in accordance with claim 9, further comprising:
a control unit; and
a motor connected to said controller for actuating said valve element.

12. A device in accordance with claim 11, wherein the preset manipulated variable has a signal curve alternately rising proportionally or declining proportionally.
